(19) United States
(12) Patent Application Publication
(10) Pub. No.: US 2005/0166144 A1
(43) Pub. Date: Jul. 28, 2005

(54) Method and system for assigning a background to a document and document having a background made according to the method and system

(75) Inventor: David Gross, North Lachisch (IL)

Correspondence Address: LACKENBACH SIEGEL, LLP, LACKENBACH SIEGEL BUILDING, 1 CHASE ROAD, SCARSDALE, NY, 10583, US

(73) Assignee: MathCom Inventions Ltd., North Lachisch (IL)

(21) Appl. No.: 10/762,632

(22) Filed: Jan. 22, 2004

(51) Int. Cl. G06F 17/00

(52) U.S. Cl. 715/526

(57) ABSTRACT

This invention is concerned with a method and system for indicating selective parameters in a document, comprising: defining parameters for affecting the document; defining a function which includes the defined parameters as variables; providing a background generator receiving the function result as an input, for accordingly outputting a background relative to the input; and checking the document and substituting actual values reflecting the parameters to the function variables, and activating the function to obtain and provide results to the background generator, to produce and apply a specific background to the document, and the system produces a background to a document, and includes an electronic document with associated parameters; parameters retrieving and value generator for examining predefined parameters, and providing values to variables of a predefined function; a predefined function including variables, for producing an output result, which is provided to a background generator; and a background generator receiving the function output result, for accordingly applying to the document a specific background relative to the function result.

### FIELD OF THE INVENTION

The present invention relates to the field of visualizing and verifying documents or portions of documents. More particularly, the invention relates to a method and a system for visually indicating the proper inclusion of data in documents.

### BACKGROUND OF THE INVENTION

In the present-day business world, a vast amount of various documents are prepared and/or transferred between persons or sites every day. Very frequently, such documents include some information which is of substantial importance. In other cases, there is the need to attach to a given document secured information, the purpose of which is to indicate and/or identify the status of the document, for example, regarding the location and time the document was prepared, the person who prepared (or signed) the document and whether he was authorized to sign the document, the validity of the document, etc.

Concealed/transparent information exists today only in physical documents, and only for limited purposes, such as indicating whether a document had been copied. Such techniques are generally based, for example, on the chemical properties of the paper on which the document is printed, and their sole purpose is as is mentioned hereinbefore; i.e. changing the document background colors/pattern only as a result of copying the document. These techniques and methods are incapable of changing the background (colors or pattern) while the document holder fills in the required details. In other words, there is no relation between the content of the document and its background.

There are currently computer software packages capable of indicating various parameters regarding documents. For example, Microsoft WORD shows the user document details, such as page and line numbering, statistics (e.g., total number of words), etc. However, these parameters do not affect the background color or pattern. Moreover, these parameters are software dedicated; e.g., Microsoft WORD software has its own dedicated parameters, and so does Microsoft EXCEL, etc. These parameters form, therefore, a fixed, non-flexible and limited set of parameters.

The inventor has found that there are many uses in which dynamically changing document background color(s) and/or pattern in accordance with various parameters, for example, parameters included or related to the content of the document, is advantageous. Such parameters may depend on the text content of the document, or are ‘hidden’. One example for such parameters is the date or time at which a document is written or signed.

Another example is the document signatory. Still another example is the computer in which the document was opened and received.

It is an object of the present invention to provide a method for producing electronic documents, in which the background of one or more selected areas, or of the whole document, changes according to the content in said selected areas.

It is another object of the present invention to provide a method for verifying the authenticity of documents.

Other objects and advantages of the invention will become apparent as the description proceeds.

### SUMMARY OF THE INVENTION

The present invention relates to a method for indicating selective parameters in a document, which comprises: (a) defining parameters for affecting said document; (b) defining a function which includes said defined parameters as variables; (c) providing a background generator receiving the function result as an input, for accordingly outputting a background relative to said input; and (d) checking the document and substituting actual values reflecting said parameters to said function variables, and activating the function to obtain and provide results to the background generator, to produce and apply a specific background to the document.

According to one embodiment of the invention the document is an electronic document.

For this purpose, the document is a document which is preferably previously scanned to form an electronic document.

The applied background may span a portion of the document, or the entire document.

Preferably, the appearance of the resulting background from the background generator varies in shade, and/or color, and/or shape, and/or pattern, according to the function result.

According to one embodiment of the invention, the document, function, and generator are conveyed together from a first entity to a second entity for applying values at said second entity to said parameters, activating the function and background generator to produce a specific background to said document, depending on the said parameter values. A more specific feature of this embodiment, is the possibility of having the document returned with its produced background to the first entity.

According to another embodiment of the invention, the document only is conveyed from a first entity to a second entity for applying values to said parameters, and then the document is returned to said first entity, in which the function and background generator are activated to produce a specific background to said document, depending on the said parameter values.

According to still another embodiment of the invention, specific functions are provided to specific entities, for producing documents that are unique to each entity.

According to still another embodiment of the invention, specific functions are associated with specific documents or document types.

The invention can be used for efficiently verifying documents, for authenticating documents, for documents and/or product classification, and for providing easy visual identification.

When documents are created and printed with their produced background according to the invention, the invention provides a means for document verification, document authentication, document and products sorting, means for easy visual identification, and means for documents and products classification.

The invention also provides for the different documents to be attached to different objects, for providing easy visual identification and classification.

As part of the easy visual identification, the application of a specific background to the document includes variation of the appearance of the text of the document.

In one embodiment of the invention, the function and background generator are continually active to produce a background for the document, while the document is edited. Alternatively, the function and background generator are active only whenever required.

The invention also provides a document containing a background made by the method of the invention. The document may be a printed document or an electronic document. In all said documents, the background is a function of predefined parameters related to said document.

In one embodiment of the invention, the output from the function is a value enabling the background generator to produce a homogenous background. In another embodiment, the output from the function is a pixel-matrix enabling the background generator to produce a non-homogenous or a complicated background.

The invention provides for an electronic document containing a background made by the various methods indicated and described above.

The invention also provides for a printed document containing a background of various methods described above.

In accordance with the teachings of this invention, an electronic document, the background of which is a function of predefined parameters related to the document is provided.

It should also be noted that another feature of the invention is that the parameters are associated with or obtained from the computer system in which the document is located, or from its periphery.

The invention also relates to a system for producing a background to a document, which comprises: (a) an electronic document with which parameters are associated; (b) a parameters retrieving and value generator for examining predefined parameters, and providing values to variables of a predefined function; (c) a predefined function including variables, for producing an output result, which is provided to a background generator; and (d) a background generator receiving the function output result, for accordingly applying to the document a specific background relative to the function result.

In one embodiment of the system of the invention, the output result from the function is one value. In another embodiment of the invention, the output result from the function is a pixel matrix indicating shade and/or color values of pixels over the background.

Specifically, the parameters are associated with or obtained from the computer system in which the document is located, or from its periphery.

### BRIEF DESCRIPTION OF THE DRAWINGS

In the drawings:

FIG. 1 schematically illustrates a general layout and functioning of the invention, according to one embodiment of the invention;

FIG. 2 schematically illustrates various parameters which can affect the document background, according to one embodiment of the invention;

FIG. 3 is a block diagram illustrating a first variant of the invention;

FIG. 4 is a block diagram illustrating a second variant of the invention;

FIG. 5 is a block diagram illustrating a third variant of the invention;

FIG. 6 illustrates exemplary backgrounds that are generated according to the present invention;

FIG. 7 schematically illustrates another general layout and function of the invention, according to an embodiment of the invention; and

FIG. 8 illustrates still another embodiment of the invention, for authenticating documents.

### DETAILED DESCRIPTION OF PREFERRED EMBODIMENTS

According to the present invention, the background of a document is relative to its content or to one or more predefined parameters within said document.

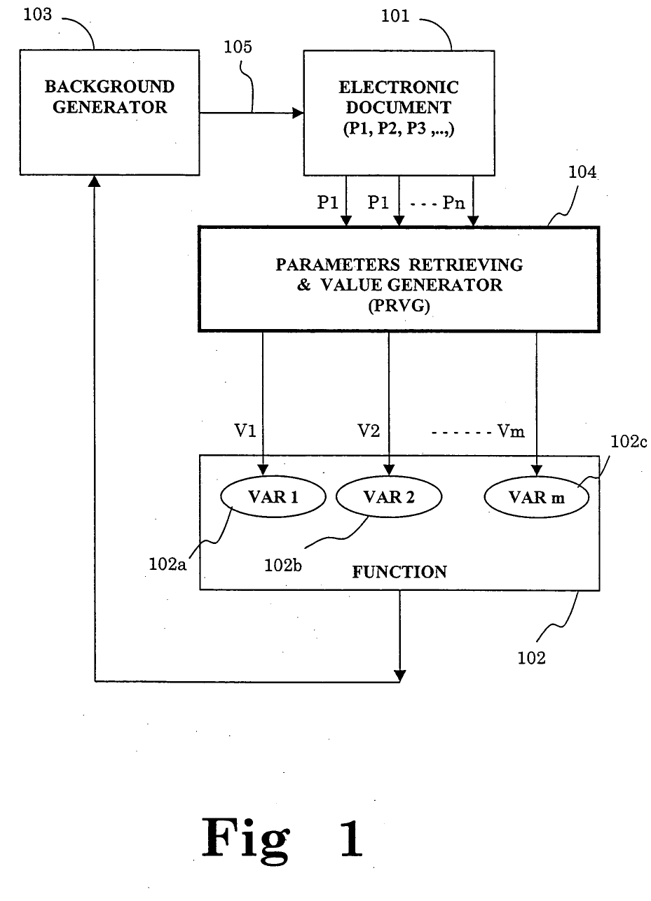

FIG. 1 illustrates a general layout and function of the invention. The invention comprises four major parts: electronic document 101; function 102; background generator 103; and ‘Parameters Retrieving and Value Generator’ (PRVG) module 104. According to the present invention, several parameters are associated with a document, for example, P1, P2, P3 and P4 to . . . PN. A function 102 comprises variables, such as VAR1, VAR 2 to VARm (102a, 102b, 102c, respectively). The parameters Retrieving and Value Generator (PRVG) 104 checks the output parameters of the document 101, to obtain and assign values to each of the function variables. The said assigned values depend on the content of said document parameters. The function 102 provides the background generator 103 background values for producing a background that is applied to the whole, or to a portion of the document. The output of background generator is applied by feed 105 to document 101.

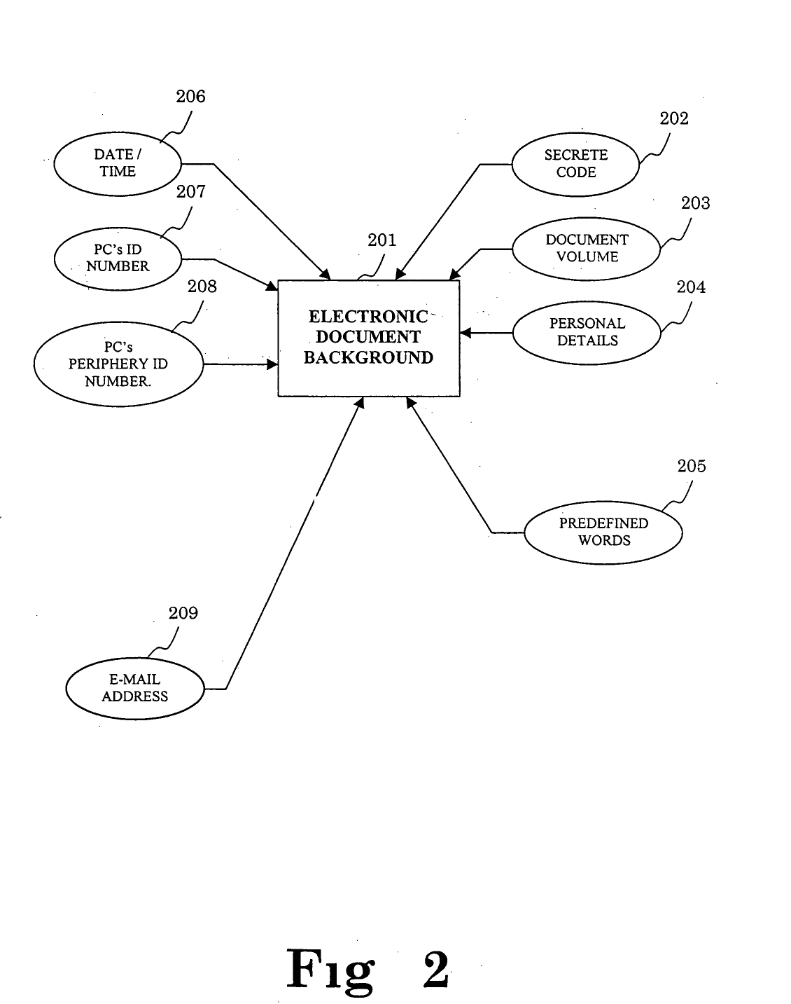

FIG. 2 indicates some optional parameters P1, P2, P3, . . . . Pn, that may be associated with a document as follows and, it should be noted that the individual parameters are provided with reference numerals and have the arbitrary designations P1, P2, P3 . . . PN, etc.:
1) ‘Secret code’ 202—some embodiments require entering a secrete code prior to entering data into the document. After the insertion of this code, the Electronic Document Background, generally designated as function 201, which is embedded in the document in this embodiment, compares the entered code with the expected code, after which the function delivers a command to the background generator to generate and visualize the corresponding background. The changing background may be at the area containing the code or elsewhere in the document. As an option, inserting the incorrect code will prevent inserting an additional data into the document (i.e., the document is ‘locked’).
2) ‘Document volume’ 203—changing the volume of a document initiates changing the corresponding background, giving the user a real-time visual estimate of how much the volume of the document has changed; i.e., number of characters or words.
3) ‘Personal details’ 204—the background of a document changes in accordance with the user's personal details, such as Identification Number (ID), address, phone number, bank account, credit card number.
4) ‘Predefined words’ 205—entering predefined words into a document changes the background.
5) ‘Date/Time’ 206—this option is similar to the ‘predefined word’ option, except that the ‘Date’ and ‘Time’ values constantly change. Additionally or alternatively, this parameter is used to determine expiration date/time, after which the background changes to indicate the fact that this document is overdue. The Date and Time can be provided from various sources, whether locally or from remote locations. Additionally, these parameters can be retrieved for the function by sending a request signal to a remote server, or it can be initiated by external means, such as a remote server.
6) ‘PC's ID number’ 207—this parameter indicates by the color of the document background the PC on which the document was prepared or changed, for example.
7) ‘PC's periphery ID number’ 208—this parameter permits a user to use his input and output devices, such as a printer, regarding a specific document. For example, a user cannot print a specific document unless his printer ID number is specified in a corresponding function.
8) E-mail address 209—the background of an area occupied by said E-mail address is changed in accordance with an E-mail address. In other words, the E-mail address is considered, by the background generator, as a predefined parameter being dependent on characters, URL or IP address.

Israeli Patent Number 121431 in the name of the inventor of the present application, discloses a function and a background generator for producing a background relative to the function output. The function and background generator as disclosed in IL 121431 may be used in accordance with the present invention.

With reference to FIG. 1, according to the present invention the PRVG 104 checks the status or content of the predefined parameters associated with the document, P1, P2, . . . , Pn. It converts said parameters to values for the function 102 variables. According to one embodiment of the invention, predefined-weighted values are assigned to each character. For example, the ASCII code may be used for that character's assignment. Therefore, the function will provide a different output if it finds, for instance, a family name ‘Smith’ than if it finds a family name ‘Fisher’. In any case, the output of the function is generally a result of a manipulation of several parameters. In a simple embodiment of the invention, the function outputs to the background generator to generate one value, in which case the background generator produces one homogeneous background. In a more complicated case, the function produces a pixel-based matrix defining a shade level and/or color for each pixel within the background area. The background generator is provided with the said matrix, in turn producing a corresponding background that is visually applied to the document.

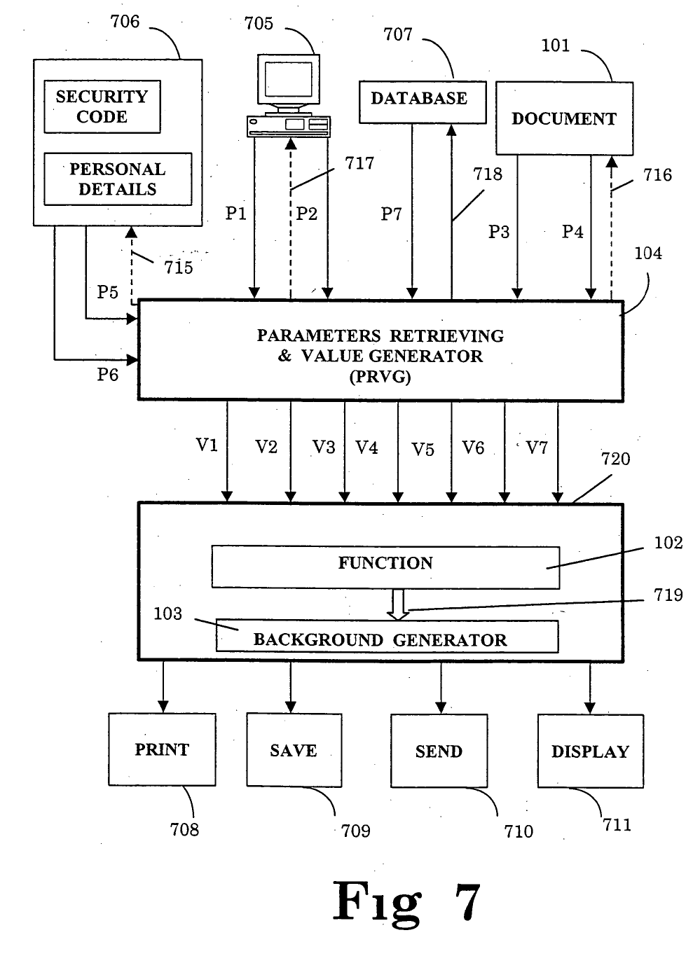

Referring now more particularly to FIG. 7 which shows a block diagram illustrating the invention in more detail. The PRVG unit 104 examines, arrow 716, the document 101, and obtains from it parameters P3 and P4. It optionally further obtains, as indicated by arrow 717, additional parameters from the user PC 705 [of the user 705], for example, its serial number and the current time, parameters P1 and P2. Still optionally, the PRVG may require the user to enter a secret code, such as a password P5, and other personal details, P6. The PRVG, after receiving a parameter P1, P2, . . . etc. may refer arrow 718, to a look-up table or database 707 for obtaining another parameter, for example, P7.

Then, the PRVG unit substitutes values in all the predefined variables of the function, for example, V1, V2, V3, . . . V7. The substituted values reflect the parameters P1-P7 in some manner. For example, if P4 is the name “JOHN”, a value 724 may be substituted for V4. If, however, the name is “SAM”, a value 520 may be substituted for V4. Therefore, the parameters may be evaluated, converted or manipulated by the PRVG unit 104, to obtain the values for substitution. In some other cases, parameters may be directly substituted as values for the variables of function 102.

Then, the predefined function 102 performs calculations and provides its results 719 to background generator 103. In the simplest case, the output from the function is a same numerical value for all the pixels of the background area, which causes the background generator to produce a homogeneous background. In a more complicated case, the output from the function is a pixel-matrix, providing specific values to each pixel in the background. The background generator produces a background to the document or a portion thereof according to the results 719 it is provided with.

The document which includes the produced background is then displayed 711, printed 708, saved 709, or sent (send function) 710 to another destination.

The document itself may be an electronic document, or a scanned document in graphic or text format, with which the parameters are associated. When the parameters are portions or fields of the document, they also may be in graphic or text format.

According to the invention, the function may be affiliated into the background generator or be an independent entity. Alternatively, any combination from the group of document, function, PRVG module and background generator may form one entity.

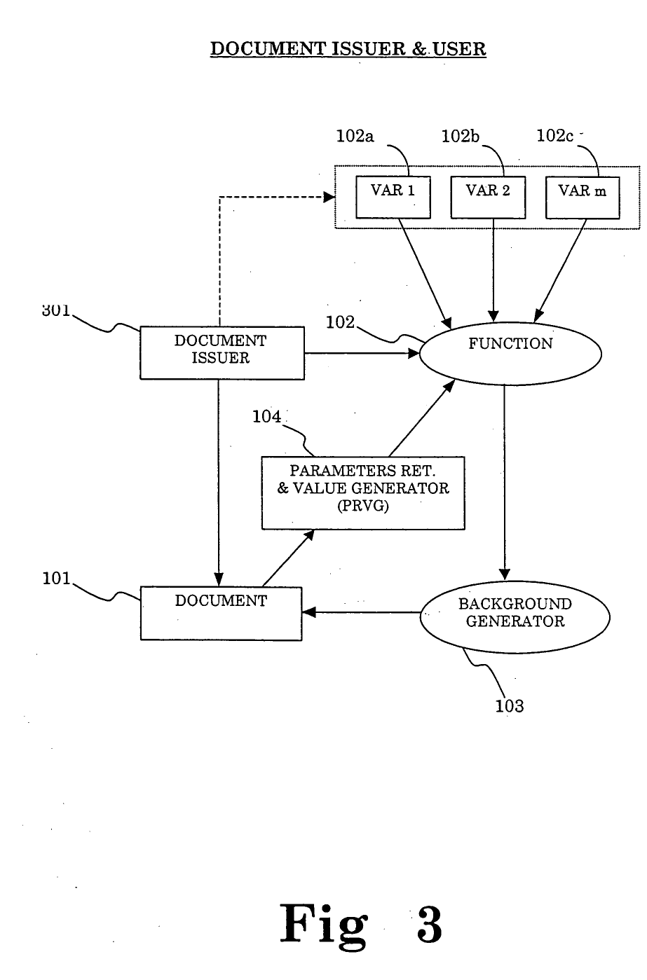

According to a first variant of the invention, as shown in FIG. 3, the document, function and background generator remain local at the PC of the person who is producing the document.

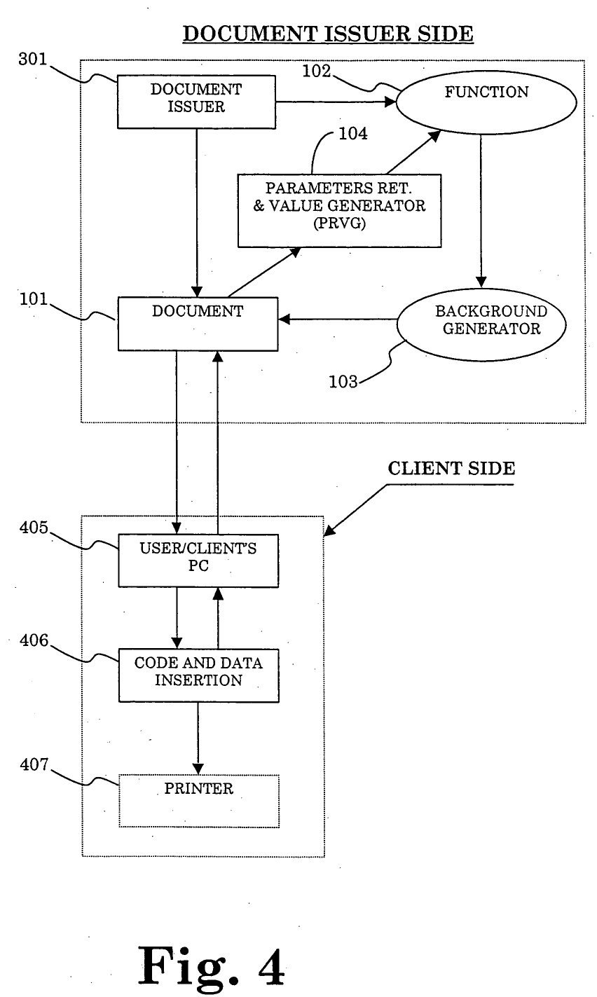

According to ˜a second variant of the invention, as shown in FIG. 4, there is a document issuer who has the function and the background generator, and a client who receives a document (for example, a form) to complete. When the document is returned to the issuer after completion by the client, the issuer applies the function and the background generator on the document to examine the various parameters as defined.

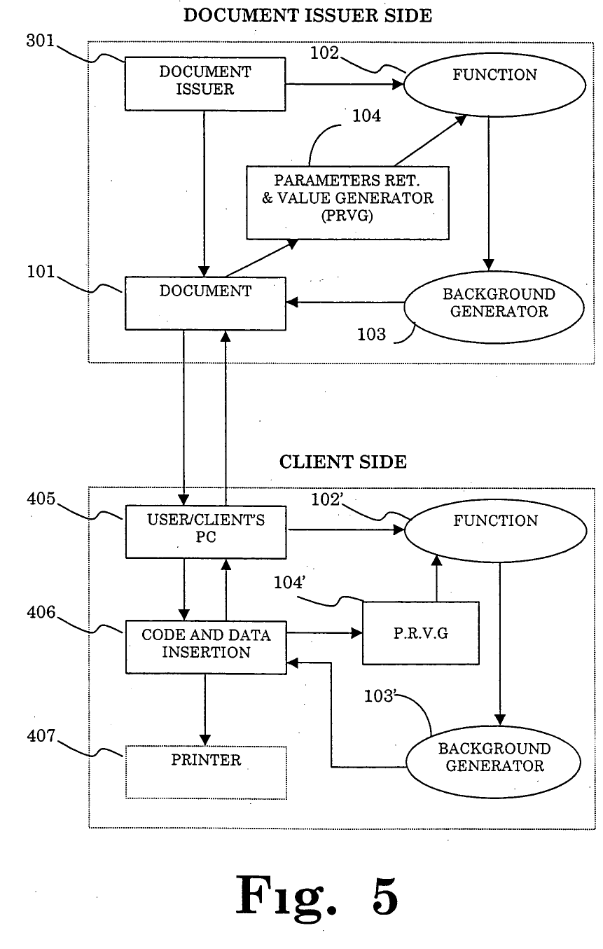

According to a third variant of the invention, as shown in FIG. 5, a specific function and background generator are provided to the client, which produces a background to the document according to predefined parameters. Then, the document is returned to the issuer, who can assess it according to the background.

Hereinafter, embodiments will be exemplified for each of the above three variants. However, it should be noted that there are many variations in which the invention can be used.

Regarding the first variant (see FIG. 3), the invention may be utilized for example in the pharmaceutical industry. Currently, for example there are medicines having similar names, which introduce the risk of replacement in the pharmacy when sold to clients. Sometimes only a few letters may differentiate between two or more medicine names. According to an embodiment of the invention, a color standard (code) is defined, according to which each medicine is assigned a unique background. At least a portion of the label of each medicine is provided with a corresponding color code of said medicine as defined.

According to the invention, a medicine manufacturer attaches to each bottle or pharmacy package a color-coded label, as is uniquely assigned. The labels are created by typing the name of the medicine into a computer, after which the color code is visible. The next step is to print the color pattern and the name of the drug on a special label, and the color-coded label is attached to the medicine package. When a patient goes to a physician, the physician enters into his computer the name of the medicine, thus creating a ‘document’ which includes both the name of the medicine and the drug's unique color code. The physician then prints the prescription, including a label embedded in it with the assigned color code of the specific medicine. Then when the patient goes to the pharmacy, a comparison may be made by either the pharmacist or the client, to verify that the background appearing on the prescription matches the background on the label of the medicine label. It should be noted that the PC of the manufacturer and the physician are provided with a background generator and a suitable function for printing the labels or prescriptions accordingly.

There are, however, several drugs that are manufactured by multiple pharmaceutical companies. Therefore, according to still another embodiment of the invention, whenever a physician enters a drug name into his computer, a first manufacturer's color-code appears on the ‘document’, and a few more alternative color codes, representing substitutions manufactured by other companies, also appear on said document alongside the first color-code. When presented with a prescription, the pharmacist can choose one of the drugs according to the color codes appearing on the prescription.

According to another embodiment of the present invention, the background of medicines matches their dosages. For example, a 500-mgr. pill has a different background than a 200-mgr. pill of the same medicine.

According to still another embodiment of the present invention, the background of medicines matches the expiration date (i.e., year and month). For example, a blue background may indicate a medicine with an expiration date in January. Similarly, a different color is assigned to each month of the year. Years may also be assigned unique backgrounds. By utilizing this embodiment, a pharmacist can readily distinguish (i.e., at a glance) medicines with expired dates, and respond accordingly.

Most of today's word processors have an option to be configured to automatically save documents after a predefined time (e.g., every 5 minutes), no matter how many characters have been added since the last time the document was saved. If the file is large, multiple savings of the file become burdensome. According to another embodiment of the first variant of the invention, an indication is given as to the number of changes to the document since the last saving. In that case, the function contains the parameter of the number of changes. A portion of the user's screen indicates the number of changes in the document. The function, therefore, causes the background generator to generate a background to said screen portion for indicating the number of changes. For example, said portion may change its color from yellow to orange and then to red, depending on the number of changes in the document. In still another option, a parameter combination reflecting the last time the document was saved and the number of changes may be applied.

FIG. 3 is a block diagram illustrating one layout and functioning of the invention (i.e. a first variant). A document issuer 301 issues or generates a document 101. A function 102 is also defined by the document issuer 301, comprising in it predefined variables, such as 102a through 102c. The variables may be selected, for example, from the group of variables described in FIG. 2 (202 through 208) or from other variables. The user may reconfigure function 102 whenever necessary.

The PRVG Module 104 is also configured, by document issuer 301, to retrieve the current status (i.e. values) of relevant parameters from document 101, and to assign a specific weight to the retrieved values. The values as produced by the PRVG 104 are then forwarded to the function 102 and substituted for the variables VAR1 to VARm (102a to 102c, respectively) for further calculations, after which function 102 outputs one, or more, values to the background generator 103, for applying a background to the document. It should be noted again that the function provides to the background generator a pixel matrix. In a simple case, all the components of the matrix are identical so that the background generator produces a homogeneous background area. In a more complicated case, the values of the components of the pixel matrix may be different, to produce a non-homogeneous background.

The invention may be configured to change the background of the document continuously according to any change in the document parameters, or discretely. Moreover, the generator may change the background of only a portion of the document page or its entirety. In the case of FIG. 3, the document issuer is also the user of the document.

FIG. 4 illustrates the second variant of the invention. A document issuer in the Document Issuer Side defines function 102 and document parameters (not shown). A document for completion is sent to client in the User/Client's PC 405 the Client Side. The client 405 fills in the document, thereby assigning values to said parameters. The client then returns the completed document to the issuer, where the parameter values are examined at the issuer side or end by PRVG 104. The PRVG 104 provides values to the function 102 variables after which said function provides inputs to the background generator to generate a background to the document accordingly. The produced background reflects the values relating to the data entered by said client into said document as defined. This enables the issuer to assess or classify the document according to the background. The defined document parameters may be, for example:
(1) The date in which the document is completed: in such a case documents completed on different dates will receive different backgrounds.
(2) A password: if the password is entered correctly, a corresponding background will be issued, reflecting the validity of the password. Otherwise, a different background will be issued, reflecting invalidity.
(3) An ID of the client's computer system: in such a case, a background reflecting validity will be issued only if said ID number matches the expected ID of the client system as is known by the issuer.

Regarding the second variant of FIG. 4, the invention can also, for example, be utilized in the banking system. A bank (issuer 301) sends a document 101 to a client 405. The client 405 fills in at step 406 the copy of document 101 and returns it to the bank, where it is examined by a PRVG 104. The PRVG 104 is configured to check various details in the document, such as an account number and a special code. Receiving various document backgrounds at the bank can make it easier for the bank teller to classify and assess the document/client. In this case, the client has no knowledge of which parameters are checked or examined by the bank.

According to still another embodiment of the invention, changing a document is restricted in at least one way. For example, if a negotiable document is to be completed by a user/client within a certain ‘time frame’, any attempt to fill out or complete this document at other times will result in changing the document's background to a predefined background, as is defined in the function.

Furthermore, the document issuer may include within the function an ID of a PC or a printer to allow a user to print the document only from a specific PC or printer as defined in the function. Any attempt to print said document by using another PC or printer, results in changing the background of the document. This option may allow easy detection of any attempt to produce a fraudulent document.

Furthermore, in still another embodiment of the invention, the security of a document can be enhanced. Whenever a user decides to stop working on a file (whether a text or other), a special code is sent by the user to the PRVG in order to indicate that this document is a ‘sealed’ file. Furthermore, the function at this stage is updated to output, in case of any small change from the original document content, a significant change in the background. Should anyone but the user change any detail in this locked file, the change(s) are forwarded to the PRVG module, of which value(s) is forwarded to the function, after which another value(s), being generated and sent by the function to the background generator to change the background accordingly, so as to indicate to the user that his file has been changed by an unauthorized user. This method allows, therefore, verifying the authenticity of a document.

FIG. 5 is a block diagram illustrating a third variant of the invention. This variant is similar to that described in FIG. 4, except that in this case, function 102 and background generator 103 are also sent to the client together with the document. In this case, there are several options for sending the function and generator. One option is to affiliate them into the document that is sent to the client. The second option is to send them as separate software modules, which can be installed in the client's PC at any time, regardless of a specific document. As noted, the Client Side in this embodiment additionally includes function 102′ and background generator 103′, and in all other respects is similar to the client side in FIG. 3. In addition, the FIG. 4 embodiment on the client side also includes PRVG 104′. The document can, therefore, be examined (either visually or by utilizing a dedicated software) both by the issuer, providing that the document is sent back to him, and by the client. ‘Examination’ of the document means that the document background is set according to the results of functions 102 and/or 102′, and can be visually checked. The function of PRVG 104 (and 104′) is the same as described in FIGS. 3 for the Document Issuer Side and 4 for the Document Issuer Side and the Client Side.

The third variant of FIG. 5 may be utilized in the education field. For example, a teacher sends a document in the form of an examination format. The background of the examination document is changed according to the answers given by the student(s). For example, correct answers are given a yellow color and incorrect answers red. When the examination is returned to the issuer, the final grade of the examination is calculated by summing up the ‘yellows’ and ‘reds’. Moreover, a background in a specific predefined portion of the document may indicate the final grade.

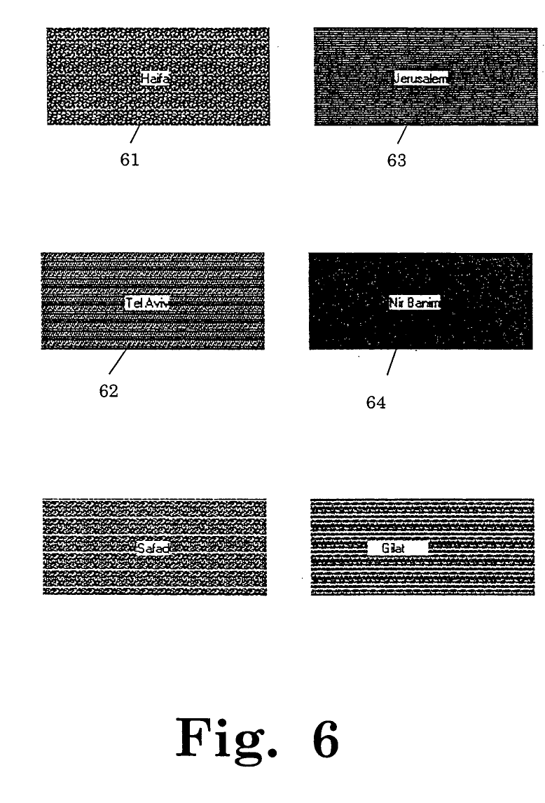

FIG. 6 illustrates still another embodiment of the invention, wherein the background changes according to a city name entered in a document. It should be noted that the backgrounds depicted in FIG. 6 have been created in accordance with this new invention. As can be seen in FIG. 6, entering the city ‘Haifa’ results in a document 61 with a background pattern different from those of ‘Tel Aviv’ 62; ‘Jerusalem’ 63, or ‘Nir Banim’ 64. More particularly, when the predefined parameter of the document is the city name, the background of the document, which is produced by the background generator, is a function of the name of the city. It should be noted that the backgrounds of the “documents” 61-64 of FIG. 6 differ also in their color, a fact which obviously is not visible in the black and white figures herein. Such documents, in this case in a label type, can be used, for example in airports where baggage and suitcases will receive labels with different backgrounds according to their destination, and will then be grouped accordingly. The invention decreases chances that a luggage will be unintentionally sent by porters to the wrong destination, as the grouping of the luggage is made according to the label's background, which is unique for each destination, and can be easily visually verified.

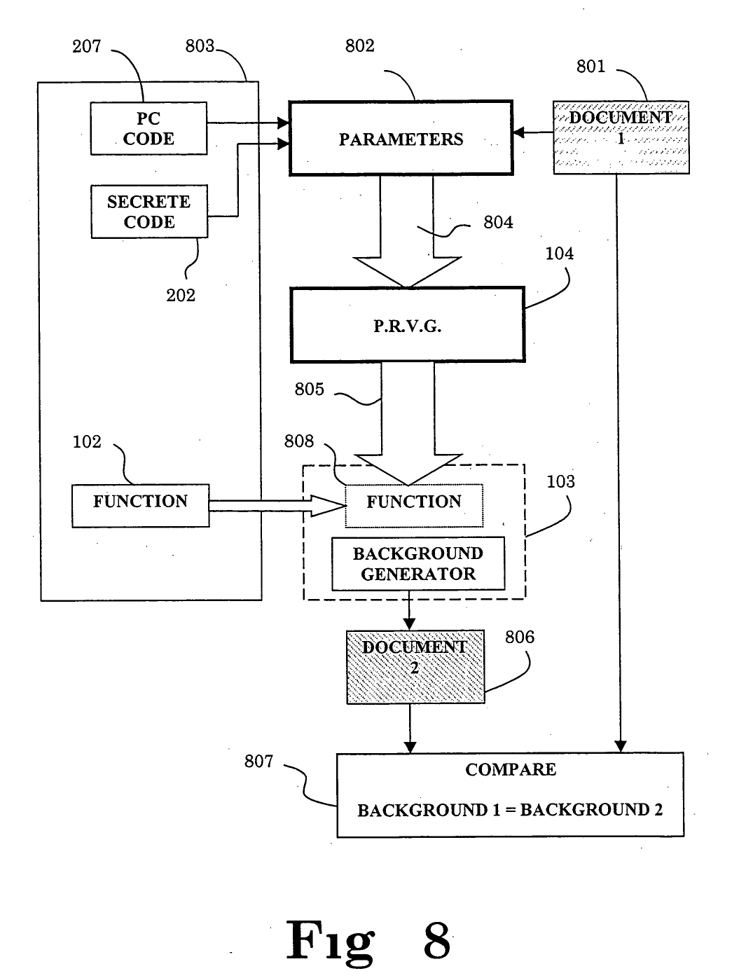

FIG. 8 describes how the authenticity of a document can be verified according to the invention. In a first stage, a first entity, for example, a bank, defines a function 102 specific for a second entity (not shown), which may be, for example, one of its clients. The function includes variables, as described above. Furthermore, the bank defines a PRVG 104 specific for each document type, indicating what parameter values to look at in a filled in document, and what parameters to substitute accordingly in the function. The bank provides to the client a copy of his specific function 102, and PRVG 104, and a copy of a standard background generator 103. The bank also provides to the client a personal secret code. Then, the bank transfers to the client a document for filling information in. The client enters into the document the required information, provides his secret code to the PRVG at his end (so that the secret code is not displayed in the document), and causes his function, PRVG, and background generator at his end to produce and apply to the document a background accordingly. Then, the document 1 of the client (801 in FIG. 8) is sent back to the bank. The system at the bank knows the parameters 802 which affected the document, it can verify from the document the values (or content) of said parameters, and it also knows the secret code of said client (as this code has been supplied to him by the bank). Moreover, the bank has a copy 102 of the function that has been provided to the client, a copy of the PRVG 104 that has been defined for the document, and a standard background generator 103. Using the said parameters 802 (from the received document) and the secret code 202 known to it, the bank uses its PRVG 104 copy to produce values 805 that are provided to the function 102 currently in use, which in turn provides to the background generator 103 a pixel matrix for producing a background of a second document 806. The background of the second document 806 is then compared by unit 807 with the background of the client's document 801. If the backgrounds are found to be identical, the bank assumes that document 801 is authentic, and has been prepared by the relevant client. If not, the bank assumes that the document is not authentic. Of course, in order to check authenticity, the bank has to provide different functions and secret codes to different clients, and it retains copies of them in its database 803. When necessary, it uses the appropriate copies relevant to the client. For example, a function 102 of the specific user is procured from the database 803, and substituted as the active function 808. Moreover, in an embodiment of the invention, one of the parameters may be an ID of the PC of the client, which is provided by the client to the bank prior to the exchanging of documents.

In accordance with still another embodiment, a parameter which is associated with a document is the time that elapsed since the last saving of the document. In that case, the document background is changed between two colors as a function of the elapsed time. For example, initially the background of the document is red, after a month it becomes orange, and after a year it is yellow. This may provide an indication of how “old” is the document since its last saving. Of course, the color changes over the electronic version of the document, but the document may become a hard copy after printing it.

It should be noted here again that parameters other than those indicated in FIG. 2 can be utilized to assign a document background according to the invention. Additionally, the background generated according to the invention may vary in color, shade, pattern, text components, picture, image, etc., or any combination thereof. Some of the current software packages that are utilized by the present invention for generating backgrounds, are, for example, PDF, GIF, TIFF, Autocad, Microsoft Word, etc.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for indicating selective parameters in a document, comprising:
a) defining parameters for affecting said document;
b) defining a function which includes said defined parameters as variables;
c) providing a background generator receiving the function result as an input, for accordingly outputting a background relative to said input; and
d) checking the document and substituting actual values reflecting said parameters to said function variables, and activating the function to obtain and provide results to the background generator, to produce and apply a specific background to the document.

2. A method according to claim 1, wherein the applied background spans a portion of the document.

3. A method according to claim 1, including varying the function result to render the appearance of the resulting background from the background generator so varies in shade, and/or color shape, and/or pattern, according to the function result.

4. A method according to claim 1, including conveying the document, function, and generator together from a first entity to a second entity for applying values at said second entity to said parameters, activating the function and background generator to produce a specific background to said document, depending on the said parameter values and returning the document with its produced background to the first entity.

5. A method according to claim 1, including conveying only the document from a first entity to a second entity for applying values to said parameters, and then the document is returned to said first entity, in which the function and background generator are activated to produce a specific background to said document, depending on the said parameter values.

6. A method according to claim 1, including providing specific functions to specific entities, for producing documents that are unique to each entity, and said specific functions are associated with specific documents or document types.

7. A method according to claim 1 wherein the document is an electronic document and is used for efficiently verifying documents, and authenticating documents.

8. A method according to claim 1, including printing the document with its produced color.

9. A method according to claim 8, including attaching different documents to different objects, for providing easy visual identification, and classification.

10. A method according to claim 1, including maintaining the function and background generator continually active to produce a background for the document while the document is edited.

11. A method according to claim 1, the function and background generator are active only wherein required.

12. An electronic document which has been previously scanned to form an electronic document and containing a background made by the method claimed in claim 1.

13. A printed document containing a background made by the method claimed in claim 1.

14. An electronic document, the background of which is a function of predefined parameters related to said document.

15. A method according to claim 1, wherein the output from the function is a value enabling the background generator to either produce a homogenous background or a pixel-matrix enabling the background generator to produce a complicated background.

16. A method according to claim 1, wherein the parameters are associated with or obtained from the computer system in which the document is located, or from its periphery.

17. A system for producing a background to a document, comprising:
an electronic document with which parameters are associated;
a parameters retrieving and value generator for examining predefined parameters, and providing values to variables of a predefined function;
a predefined function including variables, for producing an output result, which is provided to a background generator; and
a background generator receiving the function output result, for accordingly applying to the document a specific background relative to the function result.

18. A system according to claim 17, wherein the output result from the function is either one value or a pixel-matrix indicating shade and/or color values over the background.

19. A system according to claim 17, wherein the parameters are associated with or obtained from the computer system in which the document is located, or from its periphery.

20. A method according to claim 1, wherein the application of a specific background to the document includes variation of the appearance of the text of the document.
